(19) United States
(12) Patent Application Publication
(10) Pub. No.: US 2020/0299997 A1
(43) Pub. Date: Sep. 24, 2020

(54) CLOSURE STRIKER INSTALLATION JIG AND METHOD OF USING THE SAME

(71) Applicant: Honda Motor Co., Ltd., Tokyo (JP)

(72) Inventors: Barry Michael Ivan, Wasaga Beach (CA); William Robert Crane, Tottenham (CA); Michael Joseph O'Rourke, Owen Sound (CA)

(21) Appl. No.: 16/359,460

(22) Filed: Mar. 20, 2019

(51) Int. Cl. E05B 17/06; E05B 79/02; E05B 17/00

(52) U.S. Cl. CPC E05B 17/06; E05B 85/04; E05B 17/0004; E05B 79/02

(57) ABSTRACT

A closure striker installation jig is described herein. The jig includes a jig body including a striker opening and at least one fastener opening defined therein. The jig also includes at least one magnet embedded at least partially within the jig body. The jig further includes a handle rotatably coupled to the jig body at a hinge point. The handle includes a grip and at least one handle extension, wherein the grip is positioned on an opposite side of the hinge point as the at least one handle extension.

### BACKGROUND

Trunk lids and vehicle tailgates are commonly secured in a closed position using a latch and a striker. The striker may be coupled to a body of the vehicle, for example, using threaded fasteners. Jigs configured to hold the striker in place relative to the body while the threaded fasteners are tightened during assembly of the vehicle are known. Furthermore, some known jigs include a magnet to ease assembly by holding the jig and the striker together. However, the strength of the magnets currently used is limited, due to difficulties overcoming the magnetic attraction during removal of the jig after the striker is fastened to the body.

### SUMMARY

Examples of the disclosure facilitate proper installation of a closure striker and ergonomic operation of an installation jig.

In one aspect, a closure striker installation jig is provided herein. The closure striker installation jig includes a jig body including a striker opening and at least one fastener opening defined therein. The closure striker installation jig also includes at least one magnet embedded at least partially within the jig body and a handle rotatably coupled to the body at a hinge point and including a grip and at least one handle extension. The grip is positioned on an opposite side of the hinge point as the at least one handle extension.

In another aspect, a method of coupling a vehicle closure striker to a vehicle body using a closure striker installation jig is provided herein. The method includes positioning the closure striker within a striker opening defined within the installation jig, aligning the installation jig and the vehicle body, tightening at least one fastener configured to couple the closure striker together with the vehicle body, and lifting a handle of the installation jig to separate the installation jig from the striker and the vehicle body.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a rear view of an exemplary vehicle.

FIG. 2 is a perspective view of an exemplary embodiment of a closure striker that may be included in the vehicle shown in FIG. 1.

FIG. 3 is a perspective view of an exemplary embodiment of a closure striker installation jig that may be used to install the closure striker shown in FIG. 2.

FIG. 4 is a bottom view of the closure striker installation jig shown in FIG. 3.

FIG. 5 is a top view of the closure striker installation jig shown in FIG. 3 positioned on the vehicle shown in FIG. 1.

FIG. 6 is a flow chart of a method of coupling a closure striker to a vehicle body using a closure striker installation jig, for example, the closure striker installation jig shown in FIG. 3.

Corresponding reference characters indicate corresponding parts throughout the drawings. Although specific features may be shown in some of the drawings and not in others, this is for convenience only. In accordance with the examples described herein, any feature of a drawing may be referenced and/or claimed in combination with any feature of any other drawing.

### DETAILED DESCRIPTION

The present disclosure relates generally to a closure striker installation jig, and more specifically, to a closure striker installation jig that facilitates proper installation of a closure striker in an ergonomic manner. The exemplary embodiment of the closure striker installation jig includes magnets to hold the striker to the jig, and also to hold the jig to the vehicle body. The exemplary embodiment of the closure striker installation jig also includes a handle having handle extensions configured to separate the jig from the striker and from the vehicle body without excessive pull force. The exemplary embodiment of the closure striker installation jig also includes alignment features to ensure proper placement of the striker with respect to the vehicle body.

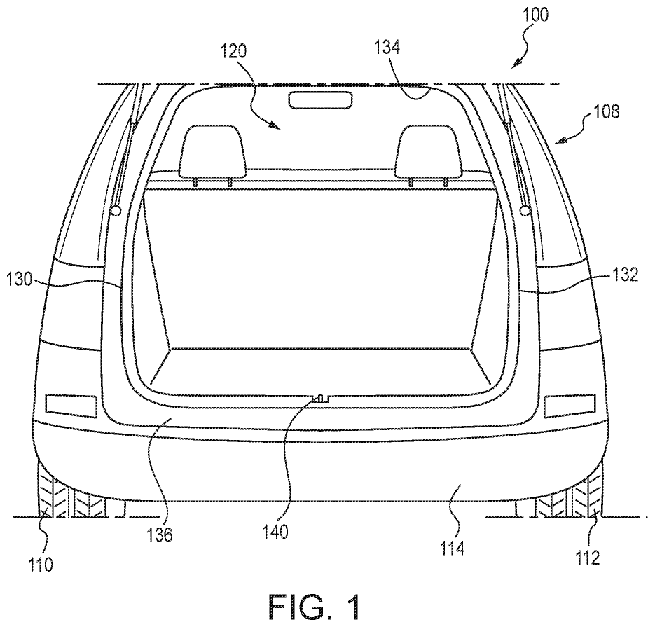

FIG. 1 is a rear view of an exemplary vehicle 100. Vehicle 100 includes a vehicle body 108, rear tires 110 and 112, and a rear bumper 114. Vehicle body 108 may be formed from a plurality of panels, for example, a first panel 130, a second panel 132, a third panel 134, and a fourth panel 136. Vehicle 100 also includes a rear tailgate opening 120 defined within vehicle body 108. More specifically, rear tailgate opening 120 may be defined by, for example, first panel 130, second panel 132, third panel 134, and fourth panel 136. Furthermore, vehicle 100 includes a closure striker 140 and a latch (not shown in FIG. 1). Although illustrated as a crossover/sport utility-type vehicle that includes a tailgate, the apparatus and methods described herein are also applicable to vehicles that include a trunk lid and/or other type of closure that utilizes a closure striker.

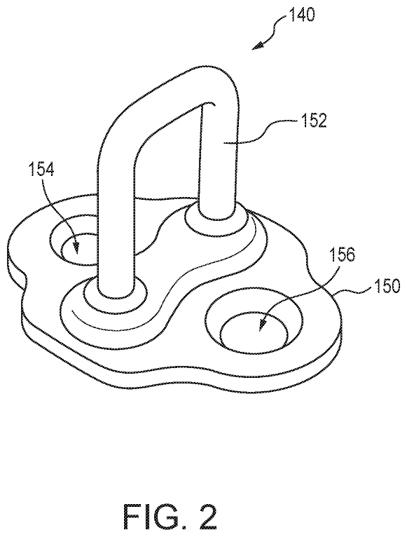

FIG. 2 is a perspective view of an exemplary embodiment of a closure striker, for example, closure striker 140 (shown in FIG. 1). In the exemplary embodiment, closure striker 140 includes a base portion 150 and a striker rod 152 extending substantially perpendicularly from base portion 150. In the illustrated embodiment, striker rod 152 has a generally C-shape or U-shape. Furthermore, a first fastener opening 154 and a second fastener opening 156 are defined within base portion 150 and are configured to receive fasteners for coupling closure striker 140 to vehicle 100. For example, screws and/or bolts may be inserted through first and second fastener openings 154 and 156 and tightened with respect to vehicle body 108 to couple closure striker 140 together with vehicle body 108.

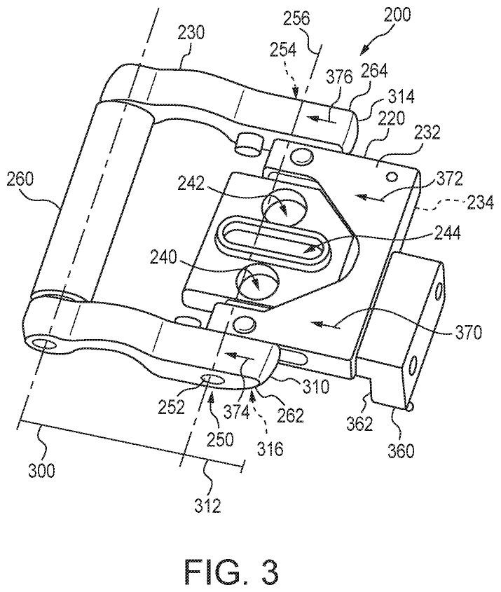

FIG. 3 is a perspective view of an exemplary embodiment of a closure striker installation jig 200 that may be used to install a closure striker, for example, closure striker 140 (shown in FIGS. 1 and 2). In the exemplary embodiment, closure striker installation jig 200 includes a jig body 220 and a handle 230. Jig body 220 includes a first surface 232 and a second surface 234. In the exemplary embodiment, jig body 220 includes a first fastener access opening 240, a second fastener access opening 242, and a striker rod opening 244 defined therein. Striker rod opening 244 is configured to receive striker rod 152 (shown in FIG. 2). Striker rod opening 244 surrounds striker rod 152, which is one aspect of jig 200 that facilitates accurate and repeatable positioning of closure striker 140 on vehicle body 108.

First fastener access opening 240 is configured such that a fastener (e.g., a screw) can be inserted through opening 240, into first fastener opening 154 and a corresponding threaded opening within vehicle body 108, and such that a tightening tool (e.g., screwdriver/DC tool) has access to a head of the fastener and is able to tighten the fastener. Second fastener access opening 242 is configured such that a fastener can be inserted through opening 242, into second fastener opening 156 and a corresponding threaded opening with vehicle body 108, and such that a tightening tool has access to a head of the fastener and is able to tighten the fastener. In alternative embodiments, the fasteners are self-drilling screws. In these embodiments, the fasteners are inserted through openings 240 and 242, and a tightening tool is used to rotate the fasteners, causing the fasteners to drill into, and mate with, vehicle body 108.

In the exemplary embodiment, handle 230 is rotatably coupled to jig body 220 at a hinge point 250. More specifically, handle 230 may be rotatably coupled to jig body 220 by a first pin 252 and a second pin 254, allowing handle 230 to rotate with respect to jig body 220 around an axis 256. Furthermore, handle 230 may also include a grip 260 and at least one handle extension, for example, a first handle extension 262 and a second handle extension 264. In the exemplary embodiment, grip 260 is positioned on an opposite side of hinge point 250 as handle extensions 262 and 264.

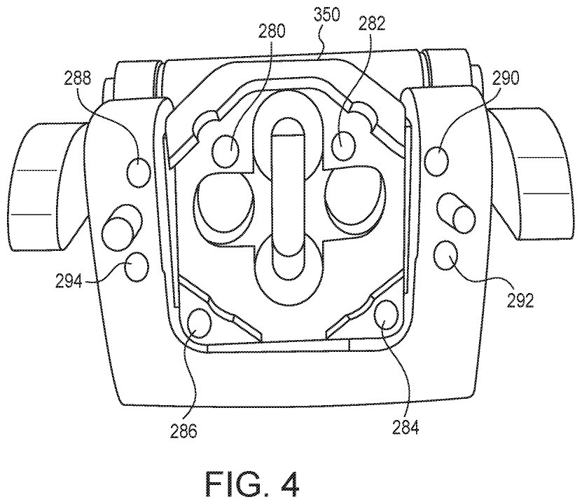

FIG. 4 is a bottom view of closure striker installation jig 200. In the exemplary embodiment, closure striker installation jig 200 also includes at least one magnet embedded at least partially within jig body 220. In the illustrated embodiment, jig body 220 includes a plurality of magnets embedded therein, for example, a first magnet 280, a second magnet 282, a third magnet 284, a fourth magnet 286, a fifth magnet 288, a sixth magnet 290, a seventh magnet 292, and an eighth magnet 294. The plurality of magnets may be embedded completely within jig body 220. Alternatively, the plurality of magnets may be embedded partially within jig body 220 with one surface exposed and flush with second surface 234 of jig body 220. Furthermore, the plurality of magnets may be embedded partially within jig body 220 and extending partially from second surface 234 of jig body 220.

In the illustrated embodiment, the plurality of magnets may be divided into a first set of magnets and a second set of magnets. For example, the first set of magnets includes first magnet 280, second magnet 282, third magnet 284, and fourth magnet 286 of the plurality of magnets. Furthermore, the second set of magnets includes fifth magnet 288, sixth magnet 290, seventh magnet 292, and eighth magnet 294 of the plurality of magnets. The first set of magnets is configured to removably couple closure striker 140 together with jig 200. Moreover, the second set of magnets is configured to removably couple jig 200 together with vehicle body 108. In the exemplary embodiment, the plurality of magnets are rare earth magnets that provide a strong hold between jig 200 and closure striker 140 and also between jig 200 and vehicle body 108.

A magnetic attraction between a magnet and a magnetic surface that is too strong to be removed by a user by merely pulling the magnet and magnetic surface apart (i.e., either impossible for an average person to pull apart or that would cause an ergonomic concern if required to pull apart repeatedly) in some instances may be overcome by sliding the magnet toward an end of the surface. However, since opening 244 surrounds striker rod 152, sliding jig 200 after the fasteners are tightened is not possible. Moreover, the strength of magnetic attraction caused by some magnets may also preclude a sliding motion. Jig 200, and more specifically, handle 230, is configured to enable an average user to overcome a strong magnetic attraction between jig 200 and vehicle body 108.

In the exemplary embodiment, grip 260 is positioned a first distance 300 (shown in FIG. 3) from hinge point 250, and an end 310 of handle extension 262 is a second distance 312 from hinge point 250. Furthermore, an end 314 of handle extension 264 is also second distance 312 from hinge point 250. First distance 300 is longer than second distance 312. Moreover, in at least some embodiments, a second surface 316 (i.e., surface positioned adjacent to vehicle body 108 during installation of closure striker 140) of handle extensions 262 and 264 is curved. More specifically, the curved surface prevents denting and/or otherwise damaging vehicle body 108 by facilitating sliding of handle extension 262 with respect to vehicle body 108 when jig 200 is being separated from vehicle body 108.

In the exemplary embodiment, grip 260 is configured to be pulled by a user after the fasteners that couple striker 140 to vehicle body 108 are tightened. Pulling grip 260 causes rotation of handle 230 around hinge point 250, further causing handle extensions 262 and 264 to press against vehicle body 108. Handle extensions 262 and 264 pressing against vehicle body 108 causes second surface 234 of jig body 220 to separate from vehicle body 108. In other words, the force applied by the user to handle 230 causes handle extensions 262 and 264 to press against vehicle body 108 with enough force to overcome the magnetic attraction between the plurality of magnets and striker 140/vehicle body 108. Handle 230 (e.g., a beam) and pins 252 and 254 (e.g., a fulcrum) act as a lever. Since first distance 300 is longer than second distance 312, the force applied by handle extensions 262 and 264 on vehicle body 108 may be multiple times greater than the force applied by the user to grip 260. The difference in force is dependent upon a ratio of distance 300 to distance 312. For example, the ratio of distance 300 to distance 312 may be approximately 3:1. Alternatively, the ratio of distance 300 to distance 312 may be approximately 4:1 or any other ratio that allows jig 200 to function as described herein. This increase in force caused by the design of jig 200 is desirable since strong magnets are also desirable in order to securely position closure striker 140 during installation.

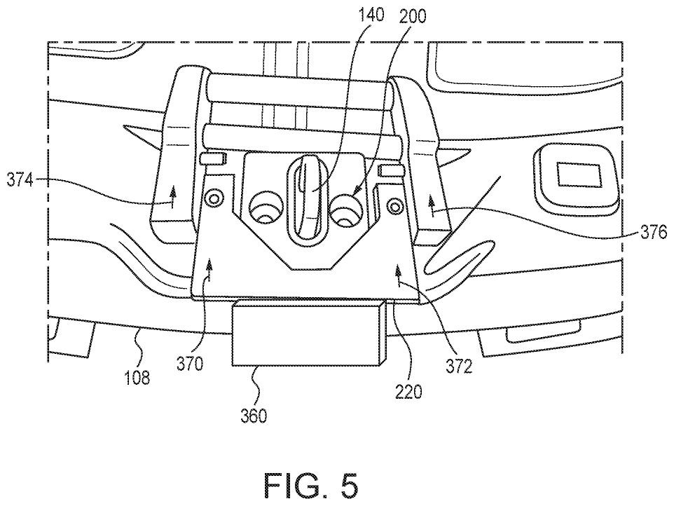

FIG. 5 is a top view of closure striker installation jig 200 positioned on vehicle 100. In the exemplary embodiment, jig 200 includes a plurality of alignment features to ensure closure striker 140 is properly positioned with respect to jig 200, and that jig 200 is properly positioned with respect to vehicle body 108. Furthermore, the user may slightly lift handle 230 to disengage jig 200 from vehicle body 108 to adjust the positioning of jig 200 with respect to vehicle body 108 if initially improperly aligned. When closure striker 140 is properly aligned with respect to jig 200 and jig 200 is properly positioned with respect to vehicle body 108, closure striker 140 will be installed in the desired position on vehicle body 108. For example, jig 200 may include a first alignment flange 350 (shown in FIG. 4) at least one of coupled to, and included within, jig body 220 for aligning closure striker 140 with respect to jig 200. In the exemplary embodiment, first alignment flange 350 extends substantially perpendicularly from second surface 234 of jig body 220. Furthermore, first alignment flange 350 has a profile substantially similar to a profile of at least a portion of an outer edge of base portion 150 of closure striker 140.

Jig 200 may also include a second alignment flange 360 (shown in FIGS. 3 and 5) at least one of coupled to, and included within, jig body 220 for aligning closure striker installation jig 200 with vehicle body 108. Second alignment flange 360 extends substantially perpendicularly from second surface 234 of jig body 220 and includes a first surface 362 configured for positioning against a predefined portion of vehicle body 108.

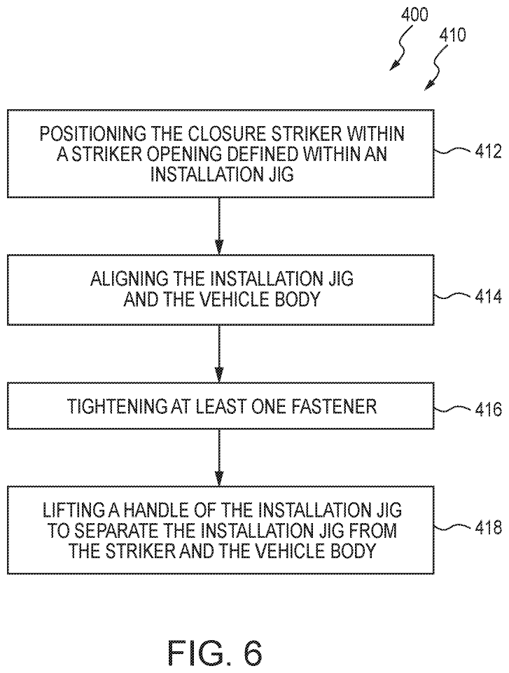

Jig 200 may also include at least one visual alignment indicia, for example, at least one of arrows 370, 372, 374, and 376 (shown in FIGS. 3 and 6). Arrows 370, 372, 374, and 376 indicate to a user the proper orientation of handle 230 with respect to jig body 220 and of closure striker installation jig 200 with respect to vehicle body 108 during installation of closure striker 140 onto vehicle body 108.

FIG. 6 is a flow chart 400 of a method 410 of coupling a vehicle closure striker to a vehicle body using a closure striker installation jig, for example, closure striker installation jig 200 shown in FIG. 3. In the exemplary embodiment, method 410 includes positioning 412 a closure striker, for example, closure striker 140, within a striker opening, for example, striker opening 244, defined within jig 200. As described above with respect to FIGS. 3-6, jig 200 includes first alignment flange 350. In the exemplary embodiment, positioning 412 closure striker 140 within striker opening 244 further includes positioning first alignment flange 350 adjacent to an outer edge of base portion 150 of closure striker 140.

Method 410 also includes aligning 414 jig 200 and vehicle body 108 and tightening 416 at least one fastener configured to couple closure striker 140 together with vehicle body 108. As described above with respect to FIGS. 3-6, installation jig 200 further includes second alignment flange 360 and aligning 414 the jig 200 and vehicle body 108 includes positioning second alignment flange 360 adjacent to a predefined surface of vehicle body 108.

Method 410 also includes lifting 418 a handle, for example, handle 230, of jig 200 to separate jig 200 from closure striker 140 and vehicle body 108. For example, lifting 418 handle 230 causes rotation of handle 230 around a hinge point, for example, hinge point 250, further causing at least one handle extension, for example, handle extension 262, to press against vehicle body 108, which separates second surface 234 of jig 200 from vehicle body 108. As described above, jig 200 includes embedded magnets configured to removably couple closure striker 140 together with jig 200 and jig 200 together with vehicle body 108, and wherein lifting handle 230 and causing handle extension 262 to press against vehicle body 108 overcomes the magnetic attraction between jig 200 and vehicle body 108.

An example vehicle body, closure striker, and closure striker installation jig are described herein and illustrated in the accompanying drawings. The exemplary closure striker installation jig includes embedded magnets to secure the jig, and therefore the corresponding closure striker, in a desired position with respect to the vehicle body while the closure striker is coupled to the vehicle body with fasteners. Furthermore, the exemplary closure striker installation jig includes a handle having handle extensions and configured to act as a lever to facilitate ergonomic and efficient separation of the closure striker installation jig from the closure striker and the vehicle body. Examples described herein include alignment features configured to ensure proper positioning of the closure striker installation jig and/or proper use of the closure striker installation jig. Proper use of the closure striker installation jig ensures accurate and repeatable placement of the closure striker on the vehicle body. Furthermore, examples described herein include features to prevent the jig from damaging the vehicle body when being separated from the vehicle body after the closure striker is coupled to the vehicle body with the fasteners.

Having described aspects of the disclosure in terms of various examples with their associated operations, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense.

Components of the systems and/or operations of the methods described herein may be utilized independently and separately from other components and/or operations described herein. Moreover, the methods described herein may include additional or fewer operations than those disclosed, and the order of execution or performance of the operations described herein is not essential unless otherwise specified. That is, the operations may be executed or performed in any order, unless otherwise specified, and it is contemplated that executing or performing a particular operation before, contemporaneously with, or after another operation is within the scope of the disclosure. Although specific features of various examples of the disclosure may be shown in some drawings and not in others, this is for convenience only. In accordance with the principles of the disclosure, any feature of a drawing may be referenced and/or claimed in combination with any feature of any other drawing.

When introducing elements of the disclosure or the examples thereof, the articles “a,” “an,” “the,” and “said” are intended to mean that there are one or more of the elements. References to an “embodiment” or an “example” of the present disclosure are not intended to be interpreted as excluding the existence of additional embodiments or examples that also incorporate the recited features. The terms “comprising,” “including,” and “having” are intended to be inclusive and mean that there may be elements other than the listed elements. The phrase “one or more of the following: A, B, and C” means “at least one of A and/or at least one of B and/or at least one of C.”

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A closure striker installation jig comprising:
a jig body comprising a striker opening and at least one fastener opening defined therein;
at least one magnet embedded at least partially within said jig body; and
a handle rotatably coupled to said jig body at a hinge point and including a grip and at least one handle extension, wherein said grip is positioned on an opposite side of said hinge point as said at least one handle extension.

2. A closure striker installation jig in accordance with claim 1, wherein said at least one magnet comprises a first set of magnets positioned along a second surface of said jig body and configured to removably couple the closure striker together with said closure striker installation jig.

3. A closure striker installation jig in accordance with claim 1, wherein said at least one magnet comprises a second set of magnets positioned along said second surface of said jig body and configured to removably couple said closure striker installation jig together with a vehicle body.

4. A closure striker installation jig in accordance with claim 1, wherein said grip is positioned a first distance from said hinge point and an end of said at least one handle extension is a second distance from said hinge point, wherein said first distance is longer than said second distance.

5. A closure striker installation jig in accordance with claim 4, wherein a ratio of the first distance to the second distance is approximately 3:1.

6. A closure striker installation jig in accordance with claim 1, wherein said at least one handle extension includes a curved surface, wherein said curved surface is positioned adjacent to a vehicle body during installation of the closure striker.

7. A closure striker installation jig in accordance with claim 6, wherein said curved surface is configured to facilitate sliding of said handle extension with respect to a vehicle body when said closure striker installation jig is being separated from the vehicle body.

8. A closure striker installation jig in accordance with claim 1, wherein said grip is configured to be pulled by a user after a fastener that couples the closure striker to a vehicle body is tightened, and wherein pulling said grip causes rotation of said handle around said hinge point, further causing said at least one handle extension to press against the vehicle body, which separates said second surface of said jig body from the vehicle body.

9. A closure striker installation jig in accordance with claim 1 further comprising a first alignment flange at least one of coupled to, and included within, said jig body for aligning the closure striker with respect to said closure striker installation jig.

10. A closure striker installation jig in accordance with claim 9, wherein said first alignment flange has a profile substantially similar to a profile of at least a portion of an outer edge of a base portion of the closure striker.

11. A closure striker installation jig in accordance with claim 1 further comprising a second alignment flange at least one of coupled to, and included within, said jig body for aligning said closure striker installation jig with a vehicle body.

12. A closure striker installation jig in accordance with claim 1 further comprising at least one visual alignment indicia indicating to a user a proper orientation of said handle with respect to said jig body and of said closure striker installation jig with respect to a vehicle body during installation of the closure striker onto the vehicle body.

13. A method of coupling a closure striker to a vehicle body using a closure striker installation jig, the closure striker installation jig including a first set of magnets, a second set of magnets, and a handle that includes at least one handle extension, said method comprising:
positioning the closure striker within a striker opening defined within the installation jig;
aligning the installation jig and the vehicle body;
tightening at least one fastener configured to couple the closure striker together with the vehicle body; and
lifting the handle of the installation jig to separate the installation jig from the striker and the vehicle body.

14. A method in accordance with claim 13, wherein the installation jig further includes a first alignment flange, and wherein positioning the closure striker within the striker opening further comprises positioning the first alignment flange adjacent to an outer edge of the closure striker.

15. A method in accordance with claim 13, wherein positioning the closure striker within the striker opening further comprises magnetically coupling together the closure striker and the first set of magnets.

16. A method in accordance with claim 13, wherein the installation jig further includes a second alignment flange, and wherein aligning the installation jig and the vehicle body comprises positioning the second alignment flange adjacent to a predefined surface of the vehicle body.

17. A method in accordance with claim 13, wherein aligning the installation jig and the vehicle body further comprises magnetically coupling together the second set of magnets and the vehicle body.

18. A method in accordance with claim 13, wherein lifting the handle causes rotation of the handle around a hinge point, further causing the at least one handle extension to press against the vehicle body, which separates the installation jig from the vehicle body.

19. A method in accordance with claim 18, wherein lifting the handle and causing at least one handle extension to press against the vehicle body overcomes the magnetic attraction between the first set of magnets and the closure striker and the second set of magnets and the vehicle body.

20. A method in accordance with claim 13 further comprising aligning a first visual alignment indicia positioned on the handle and a second visual alignment indicia positioned on a body of the installation jig prior to aligning the installation jig and the vehicle body.
